(19) United States
(12) Patent Application Publication
(10) Pub. No.: US 2019/0016125 A1
(43) Pub. Date: Jan. 17, 2019

(54) PRINTING DEVICE, AND METHOD OF CONTROLLING PRINTING DEVICE

(71) Applicant: SII Printek Inc., Chiba-shi (JP)

(72) Inventor: Koji NAGASAWA, Chiba-shi (JP)

(21) Appl. No.: 16/029,181

(22) Filed: Jul. 6, 2018

(30) Foreign Application Priority Data
Jul. 11, 2017 (JP) 2017-135592

(51) Int. Cl. B41J 2/045

(52) U.S. Cl. CPC B41J 2/04541; B41J 2/04586

(57) ABSTRACT

The invention has an object of providing a printing device and a method of controlling the printing device each capable of reducing the number of signal lines necessary for the connection to the circuit board for controlling the head drive circuit. The printing device includes an input/output section adapted to perform input and output of data, a drive circuit adapted to perform printing based on the data from the input/output section, and output the data, which is input from the input/output section, to the input/output section, and a switching section adapted to switch an input direction and an output direction of the data to the drive circuit in accordance with a switching signal, the drive circuit is provided with a first input section and a second input section to which the data is input, a first output section adapted to output the data from the first output section to the input/output section, and a second output section adapted to output the data from the second input section to the input/output section, and the switching section switches, in accordance with the switching signal, between a state in which the data from the input/output section is input to the first input section while the data input to the first input section fails to be output to the input/output section, and a state in which the data from the input/output section is input to the second input section while the data input to the second input section fails to be output to the input/output section.

### RELATED APPLICATIONS

This application claims priority under 35 U.S.C. § 119 to Japanese Patent Application No. 2017-135592 filed on Jul. 11, 2017, the entire content of which is hereby incorporated by reference.

### BACKGROUND OF THE INVENTION

### 1. Field of the Invention

The present invention relates to a printing device and a method of controlling the printing device.

### 2. Background Art

In the inkjet printing device, printing is performed by ejecting ink from a plurality of nozzles of a head in accordance with a printing signal.

Such a printing device has, for example, a controller, a head drive circuit, and a head including a plurality of nozzles.

As such a head drive circuit, in JP-A-H02-281973 (PLT 1), there is disclosed a configuration of providing bidirectionality to at least a part of each of signal paths to make it possible to switch the signal transfer direction in order to uniform the transfer directions of the signals irrespective of the installation directions of a plurality of heads in the case of using the plurality of heads combined with each other as a head unit.

However, in the technology described in PLT 1, two sets of signal lines, namely a signal line for input and a signal line for output, are necessary, the number of the signal lines necessary for the connection to the circuit board for controlling the head drive circuit increases, and, for example, the number of pins of a connector for the connection increases to cause a problem of growth in size and increase in cost.

The invention is made in view of the problem described above, and has an object of providing a printing device and a method of controlling the printing device each capable of reducing the number of signal lines necessary for the connection to the circuit board for controlling the head drive circuit.

### SUMMARY OF THE INVENTION

In order to achieve the object described above, a printing device according to an aspect of the invention is a printing device adapted to perform bidirectional data transmission/reception including an input/output section adapted to perform input and output of data, a drive circuit adapted to output the data, which is input from the input/output section, to the input/output section so as to perform printing based on the data, and a switching section adapted to switch an input direction and an output direction of the data to the drive circuit in accordance with a switching signal, wherein the drive circuit is provided with a first input section to which the data is input, a first output section adapted to output the data, which is input from the first input section, to the input/output section, a second input section to which the data is input, and a second output section adapted to output the data, which is input from the second input section, to the input/output section, and the switching section switches, in accordance with the switching signal, between a state in which the data input from the input/output section is input to the first input section while the data input to the first input section fails to be output to the input/output section, and a state in which the data input from the input/output section is input to the second input section while the data input to the second input section fails to be output to the input/output section.

According to this configuration, by switching the settings of the input section which inputs the data to the drive circuit and the output sections which do not perform the output, it is possible to prevent the collision of the data, and therefore, it is possible to integrate the input sections and the output sections. Thus, according to this configuration, it is possible to reduce the number of the connection lines to the device for outputting data to the printing device, and thus, it is possible to achieve the reduction in size and cost of the printing device.

Further, in the printing device according to an aspect of the invention, it is possible to arrange that the switching sections are connected respectively to the first input section, the first output section, the second input section, and the second output section of the drive circuit.

According to this configuration, in the case of using the plurality of drive circuits connected to one another, the switching sections are connected outside the drive circuit. Therefore, according to this configuration, in the case of, for example, using the plurality of drive circuits connected to one another, it is possible to deal with the case by an externally attached circuit without changing the internal circuits of the drive circuits. As a result, the degree of freedom of the configuration can be enhanced. Further, according to this configuration, it is possible to reduce time and cost for design change of the drive circuits.

Further, in the printing device according to an aspect of the invention, it is possible to arrange that the switching sections are provided to the drive circuit, and are connected respectively to the first input section, the first output section, the second input section, and the second output section.

According to this configuration, since the drive circuit is provided with the switching sections, it is possible to reduce the number of constituents in the case of using the plurality of drive circuits connected to one another, and thus, reduction in size and cost of the printing device can be achieved.

Further, in the printing device according to an aspect of the invention, it is possible to arrange that the drive circuit is provided with N (N is an integer no smaller than 2) drive circuits of first, second, . . . , N-1-th, and N-th drive circuits, the first output section of the first drive circuit is connected to the first input section of the second drive circuit, the first output section of the N-1-th drive circuit is connected to the first input section of the N-th drive circuit, the second output section of the N-th drive circuit is connected to the second input section of the N-1-th drive circuit, the second output section of the second drive circuit is connected to the second input section of the first drive circuit, and the switching section switches, in accordance with the switching signal, between a state in which the data input from the input/output section is input to the first input section of the first drive circuit, the data input to the first input section of the first drive circuit is output from the first output section of the first drive circuit to the first input section of the second drive circuit, and the data input to the first input section of the N-1-th drive circuit is output from the first output section of the N-1-th drive circuit to the first input section of the N-th drive circuit, and fails to be output from the first output section of the N-th drive circuit to the input/output section, and a state in which the data input from the input/output section is input to the second input section of the N-th drive circuit, the data input to the second input section of the N-th drive circuit is output from the second output section of the N-th drive circuit to the second input section of the N-1-th drive circuit, and the data input to the second input section of the second drive circuit is output from the second output section of the second drive circuit to the second input section of the first drive circuit, and fails to be output from the second output section of the first drive circuit to the input/output section.

According to this configuration, even in the case of using the plurality of drive circuits connected to one another, by switching the settings of the input section which inputs the data to the drive circuit and the output sections which do not perform the output, it is possible to prevent the collision of the data, and therefore, it is possible to integrate the input sections and the output sections. Thus, according to this configuration, it is possible to reduce the number of the connection lines to the device for outputting data to the printing device. Thus, reduction in size and cost of the printing device can be achieved.

Further, in the printing device according to an aspect of the invention, it is possible to arrange that the drive circuit is provided with N (N is an integer no smaller than 2) drive circuits of first, second, . . . , N-1-th, and N-th drive circuits, each of the N drive circuits is provided with the switching sections, the switching sections are connected respectively to the first input section, the first output section, the second input section, and the second output section of the first drive circuit, the switching sections are connected respectively to the first input section, the first output section, the second input section, and the second output section of the second drive circuit, the switching sections are connected respectively to the first input section, the first output section, the second input section, and the second output section of the N-1-th drive circuit, the switching sections are connected respectively to the first input section, the first output section, the second input section, and the second output section of the N-th drive circuit, the first output section of the first drive circuit is connected to the first input section of the second drive circuit via the switching section of the first drive circuit and the switching section of the second drive circuit, the first output section of the N-1-th drive circuit is connected to the first input section of the N-th drive circuit via the switching section of the N-1-th drive circuit and the switching section of the N-th drive circuit, the second output section of the N-th drive circuit is connected to the second input section of the N-1-th drive circuit via the switching section of the N-th drive circuit and the switching section of the N-1-th drive circuit, the second output section of the second drive circuit is connected to the second input section of the first drive circuit via the switching section of the second drive circuit and the switching section of the first drive circuit, and the switching sections switch, in accordance with the switching signal, between a state in which the data input from the input/output section is input to the first input section of the first drive circuit, the data input to the first input section of the first drive circuit is output from the first output section of the first drive circuit to the first input section of the second drive circuit via the switching section of the first drive circuit and the switching section of the second drive circuit, and the data input to the first input section of the N-1-th drive circuit is output from the first output section of the N-1-th drive circuit to the first input section of the N-th drive circuit via the switching section of the N-1-th drive circuit and the switching section of the N-th drive circuit, and fails to be output from the first output section of the N-th drive circuit to the input/output section, and a state in which the data input from the input/output section is input to the second input section of the N-th drive circuit, the data input to the second input section of the N-th drive circuit is output from the second output section of the N-th drive circuit to the second input section of the N-1-th drive circuit via the switching section of the N-th drive circuit and the switching section of the N-1-th drive circuit, and the data input to the second input section of the second drive circuit is output from the second output section of the second drive circuit to the second input section of the first drive circuit via the switching section of the second drive circuit and the switching section of the first drive circuit, and fails to be output from the second output section of the first drive circuit to the input/output section.

According to this configuration, since the drive circuit is provided with the switching sections, it is possible to reduce the number of constituents in the case of using the plurality of drive circuits connected to one another, and thus, reduction in size and cost of the printing device can be achieved.

In order to achieve the object described above, a method of controlling a printing device according to an aspect of the invention is a method of controlling a printing device adapted to perform bidirectional data transmission/reception, the printing device including an input/output section adapted to perform input and output of data, a drive circuit adapted to output the data, which is input from the input/output section, to the input/output section so as to perform printing based on the data, and a switching section adapted to switch an input direction and an output direction of the data to the drive circuit in accordance with a switching signal, wherein the drive circuit is provided with a first input section to which the data is input, a first output section adapted to output the data, which is input from the first input section, to the input/output section, a second input section to which the data is input, and a second output section adapted to output the data, which is input from the second input section, to the input/output section, the method including the step of switching, by the switching section in accordance with the switching signal, between a state in which the data input from the input/output section is input to the first input section while the data input to the first input section fails to be output to the input/output section, and a state in which the data input from the input/output section is input to the second input section while the data input to the second input section fails to be output to the input/output section.

According to this configuration, by switching the settings of the input section which inputs the data to the drive circuit and the output sections which do not perform the output, it is possible to prevent the collision of the data, and therefore, it is possible to integrate the input sections and the output sections. Thus, according to this configuration, it is possible to reduce the number of the connection lines to the device for outputting data to the printing device, and thus, it is possible to achieve the reduction in size and cost of the printing device.

According to the invention, it is possible to reduce the number of signal lines necessary for the connection to the circuit board for controlling the head drive circuit.

### BRIEF DESCRIPTION OF THE DRAWINGS

FIG. 1 is a perspective view of a printing device according to a first embodiment of the invention.

FIG. 2 is a cross-sectional view of a liquid jet head according to the first embodiment.

FIG. 3 is a block diagram showing a schematic configuration example of the printing device according to the first embodiment.

FIG. 4 is a block diagram showing a configuration example of a head drive circuit provided to the printing device according to the first embodiment.

FIG. 5 is a diagram showing a flow of a data signal in the case in which the data signal is input from a first input section according to the first embodiment.

FIG. 6 is a diagram showing a flow of a data signal in the case in which the data signal is input from a second input section according to the first embodiment.

FIG. 7 is a block diagram showing a configuration example of a head drive circuit according to the first embodiment and having a drive circuit provided with switching sections.

FIG. 8 is a block diagram showing a schematic configuration example of the printing device according to a second embodiment.

FIG. 9 is a block diagram showing a configuration example of a head drive circuit according to the second embodiment.

FIG. 10 is a block diagram showing a configuration example of a head drive circuit according to the second embodiment and having drive circuits provided with switching sections.

FIG. 11 is a block diagram showing a schematic configuration example of the printing device 1 according to a modified example of the second embodiment.

FIG. 12 is a block diagram showing a configuration example and an example of a flow of a signal in a comparative example in which two shift registers are connected to each other.

### DETAILED DESCRIPTION OF THE INVENTION

Some embodiments of the invention will hereinafter be described with reference to the drawings. It should be noted that the scale size of each member is accordingly modified so as to provide a recognizable size to the member in the drawings used in the following description.

### First Embodiment

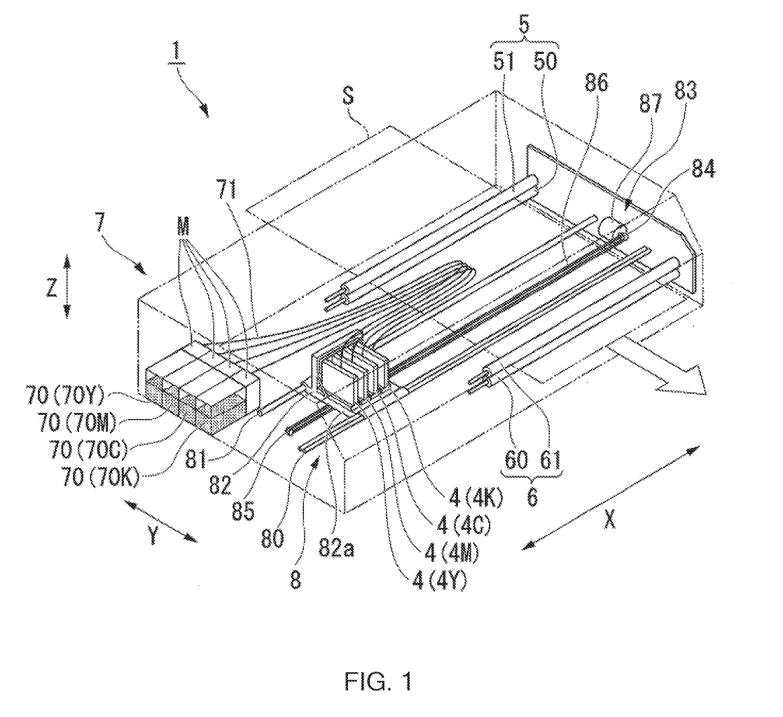

FIG. 1 is a perspective view of a printing device 1 according to a first embodiment of the invention.

As shown in FIG. 1, the printing device 1 is configured including a pair of conveying mechanisms 5, 6 for conveying a recording target medium S such as a paper sheet, liquid jet heads 4 for ejecting ink droplets to the recording target medium S, a liquid supply section 7 for supplying the liquid jet heads 4 with ink, and a scanning section 8 for making the liquid jet heads 4 perform a scanning operation in a direction (a sub-scanning direction) roughly perpendicular to a conveying direction (a main scanning direction) of the recording target medium S. It should be noted that the printing device 1 is, for example, an inkjet printer.

It should be noted that, in the following description, the sub-scanning direction is defined as an X direction, the main scanning direction is defined as a Y direction, and a direction perpendicular to both of the X direction and the Y direction is defined as a Z direction. The printing device 1 is installed so that the X direction and the Y direction are horizontal directions, and the Z direction is a vertical direction parallel to the gravitational direction, and is then used.

In other words, there is adopted a configuration in which in the state in which the printing device 1 is installed, the liquid jet heads 4 make the scanning movement on the recording target medium S along the horizontal directions (the X direction and the Y direction). Further, there is adopted a configuration in which the ink droplet is ejected from the liquid jet head 4 downward along the gravitational direction (downward along the Z direction), and then lands on the recording target medium S.

The pair of conveying mechanisms 5, 6 are respectively provided with grit rollers 50, 60 disposed so as to extend in the X direction, pinch rollers 51, 61 extending in parallel respectively to the grit rollers 50, 60, and a drive mechanism such as a motor for making the grit rollers 50, 60 perform a rotational operation around the respective axes although not shown in detail.

The liquid supply section 7 is provided with liquid containers 70 in which the ink is housed, and liquid supply tubes 71 for respectively connecting the liquid containers 70 and the liquid jet heads 4 to each other. There is disposed a plurality of the liquid containers 70, and for example, ink tanks 70Y, 70M, 70C, and 70K respectively containing four types of ink of yellow, magenta, cyan, and black are arranged side by side. The ink tanks 70Y, 70M, 70C, and 70K are each provided with a pump motor M, which pressures the ink to move to the liquid jet head 4 through the liquid supply tube 71. The liquid supply tubes 71 are each formed of, for example, a flexible hose having flexibility capable of corresponding to the action of the liquid jet head 4 (a carriage unit 82).

It should be noted that the liquid containers 70 are not limited to the ink tanks 70Y, 70M, 70C, and 70K respectively containing the four types of ink of yellow, magenta, cyan, and black, but can also be provided with ink tanks containing a larger number of colors of ink.

The scanning section 8 is provided with a pair of guide rails 80, 81, the carriage unit 82, and a drive mechanism 83, wherein the pair of guide rails 80, 81 are disposed so as to extend in the X direction, the carriage unit 82 is movably supported by the pair of guide rails 80, 81, and the drive mechanism 83 moves the carriage unit 82 in the X direction. The drive mechanism 83 is provided with a pair of pulleys 84, 85 disposed between the pair of guide rails 80, 81, an endless belt 86 wound between the pair of pulleys 84, 85, and a drive motor 87 for rotationally driving the pulley 84 as one of the pulleys 84, 85.

One of the pair of pulleys 84, 85 is disposed between one end parts of the pair of guide rails 80, 81, and the other of the pair of pulleys 84, 85 is disposed between the other end parts of the pair of guide rails 80, 81, and thus, the pair of pulleys 84, 85 are disposed so as to be spaced from each other in the X direction. The endless belt 86 is disposed between the pair of guide rails 80, 81, and the carriage unit 82 is connected to the endless belt 86. On a base end part 82a of the carriage unit 82, there is mounted the plurality of liquid jet heads 4. Specifically, the liquid jet heads 4Y, 4M, 4C, and 4K individually corresponding to the four types of ink of yellow, magenta, cyan, and black are mounted side by side in the X direction.

### (Liquid Jet Head)

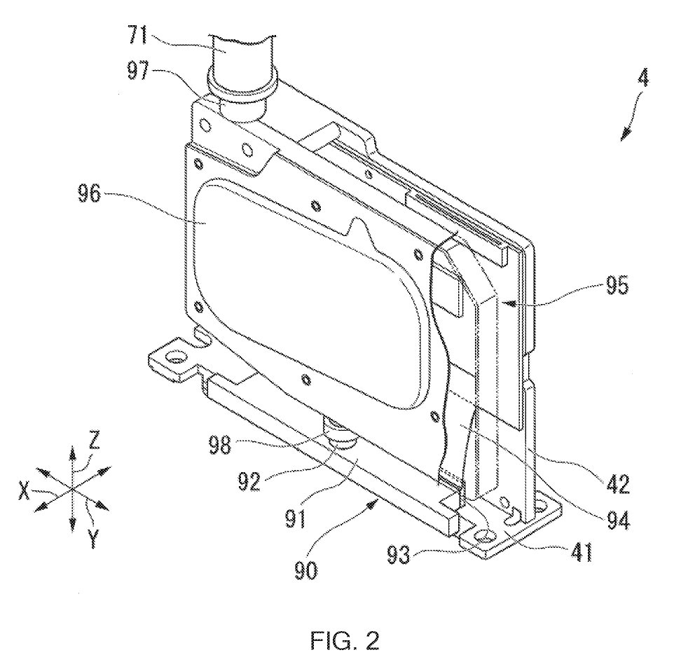

FIG. 2 is a partially broken perspective view of the liquid jet head 4 according to the present embodiment.

As shown in FIG. 2, the liquid jet head 4 is provided with a jet section 90, a control circuit board 95, and a pressure buffer 96 disposed on bases 41, 42, wherein the jet section 90 ejects the ink droplet to the recording target medium S (see FIG. 1), the control circuit board 95 is electrically connected to the jet section 90, and the pressure buffer 96 intervenes between the jet section 90 and the liquid supply tube 71 respectively via connecting sections 97, 98. The pressure buffer 96 is for making the ink flow from the liquid supply tube 71 to the jet section 90 while buffering the pressure fluctuation of the ink. It should be noted that it is also possible for the bases 41, 42 to be formed integrally.

The jet section 90 is provided with a flow channel member 91, a liquid jet head chip 93, and a flexible wiring member 94, wherein the flow channel member 91 is connected to the pressure buffer 96 via the connecting section 92, the liquid jet head chip 93 ejects the ink toward the recording target medium S as a droplet in response to application of a voltage, and the flexible wiring member 94 is electrically connected to the liquid jet head chip 93 and the control circuit board 95, and applies the voltage to the liquid jet head chip 93.

It should be noted that the configurations shown in FIG. 1 and FIG. 2 are illustrative only, and the configuration of the printing device 1 and the configuration of the liquid jet head 4 are not limited thereto.

### (Electrical Configuration of Printing Device 1)

Then, an electrical configuration example of the printing device 1 will be described.

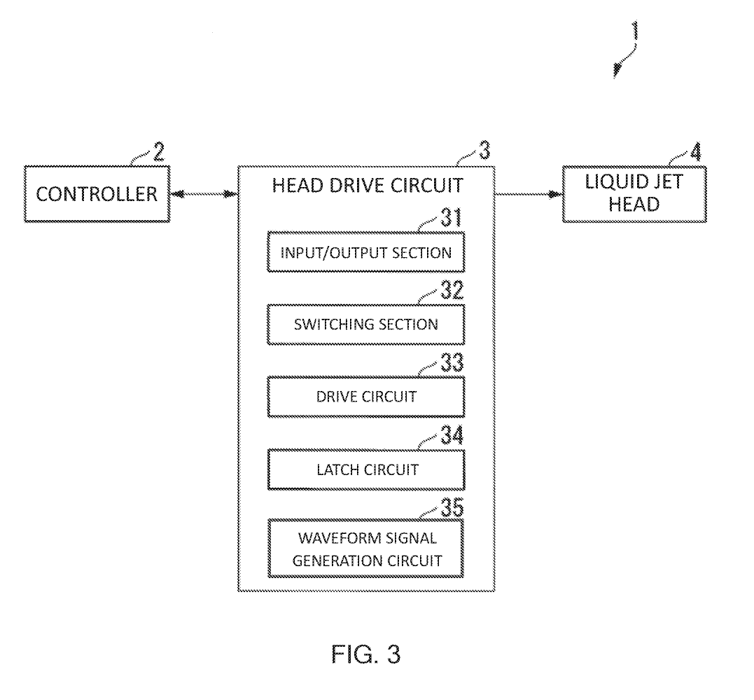

FIG. 3 is a block diagram showing a schematic configuration example of the printing device 1 according to the present embodiment. As shown in FIG. 3, the printing device 1 is configured including a controller 2, a head drive circuit 3, and the liquid jet head 4. The head drive circuit 3 is configured including an input/output section 31, switching sections 32, a drive circuit 33, a latch circuit 34, and a waveform signal generation circuit 35.

The printing device 1 performs printing by the head drive circuit 3 ejecting the ink from the liquid jet head 4 in accordance with the signal output by the controller 2. The printing device 1 is, for example, an inkjet printer. Further, the printing data included in the signal is, for example, a pixel data packet.

The controller 2 controls printing by the printing device 1. The controller 2 is, for example, a CPU (central processing unit) or an FPGA (field programmable gate array).

The head drive circuit 3 is, for example, a driver IC (integrated circuit). The head drive circuit 3 generates a waveform signal in accordance with the signal output by the controller 2, and then drives the liquid jet head 4 using the waveform signal thus generated.

The liquid jet head 4 ejects the ink in accordance with the waveform signal generated by the head drive circuit 3. As described using FIG. 1, the liquid jet heads 4 consist of liquid jet heads 4Y, 4M, 4C, and 4K corresponding individually to the four types of ink of, for example, yellow, magenta, cyan, and black.

The input/output section 31 receives the signal output by the controller 2, and then outputs the signal thus received to a shift register. The signal includes a data signal (DATA signal) as printing data, a data clock signal (DATA CLOCK signal) representing a shift timing, and a switching signal.

The switching sections 32 switch the input destination of the data signal between the two input sections provided to the drive circuit 33.

The drive circuit 33 is a shift register. The drive circuit 33 writes the printing data included in the signal output by the input/output section 31 in the register and then shifts the printing data at every timing of the data clock signal.

The latch circuit 34 performs a latch operation on the printing data written in the drive circuit 33 as the shift register.

The waveform signal generation circuit 35 generates the waveform signal corresponding to the printing data on which the latch circuit 34 has performed the latch operation, and then makes the liquid jet head 4 eject the ink using the waveform signal thus generated.

It should be noted that in the example shown in FIG. 3, there is shown an example in which the head drive circuit 3 is provided with the single waveform signal generation circuit 35 and the single liquid jet head 4, but this example is not a limitation. The number of the waveform signal generation circuit 35, and the number of the liquid jet heads 4 can each be two or more, for example, eight for each.

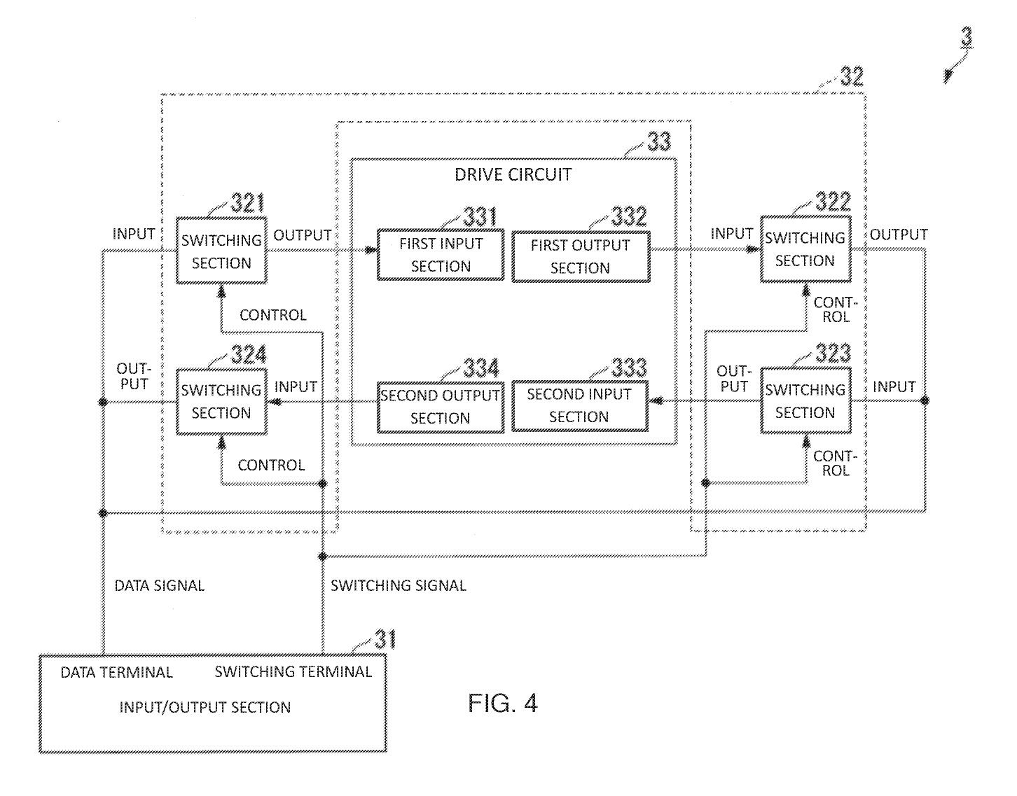

FIG. 4 is a block diagram showing a configuration example of the head drive circuit 3 provided to the printing device 1 according to the present embodiment. As shown in FIG. 4, the head drive circuit 3 is provided with the input/output section 31, the switching sections 32, and the drive circuit 33. It should be noted that in FIG. 4, the latch circuit 34 and the waveform signal generation circuit 35 are omitted from the illustration.

Further, the switching sections 32 consist of a switching section 321, a switching section 322, a switching section 323, and a switching section 324.

The drive circuit 33 is provided with a first input section 331, a first output section 332, a second input section 333, and a second output section 334.

A data terminal of the input/output section 31 is connected to an input end of the switching section 321, an output end of the switching section 322, an input end of the switching section 323, and an output end of the switching section 324. A switching terminal of the input/output section 31 is connected to a control end of the switching section 321, a control end of the switching section 322, a control end of the switching section 323, and a control end of the switching section 324.

An output end of the switching section 321 is connected to the first input section 331 of the drive circuit 33.

The first output section 332 of the drive circuit 33 is connected to an input end of the switching section 322.

An output end of the switching section 323 is connected to the second input section 333 of the drive circuit 33.

The second output section 334 of the drive circuit 33 is connected to an input end of the switching section 324.

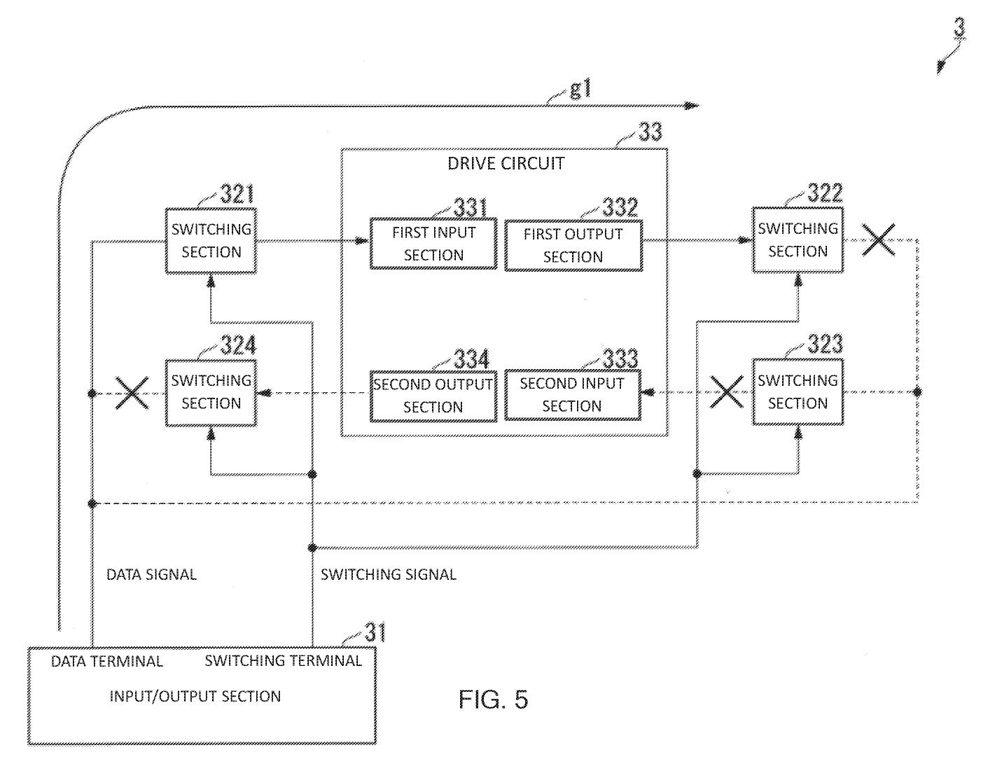

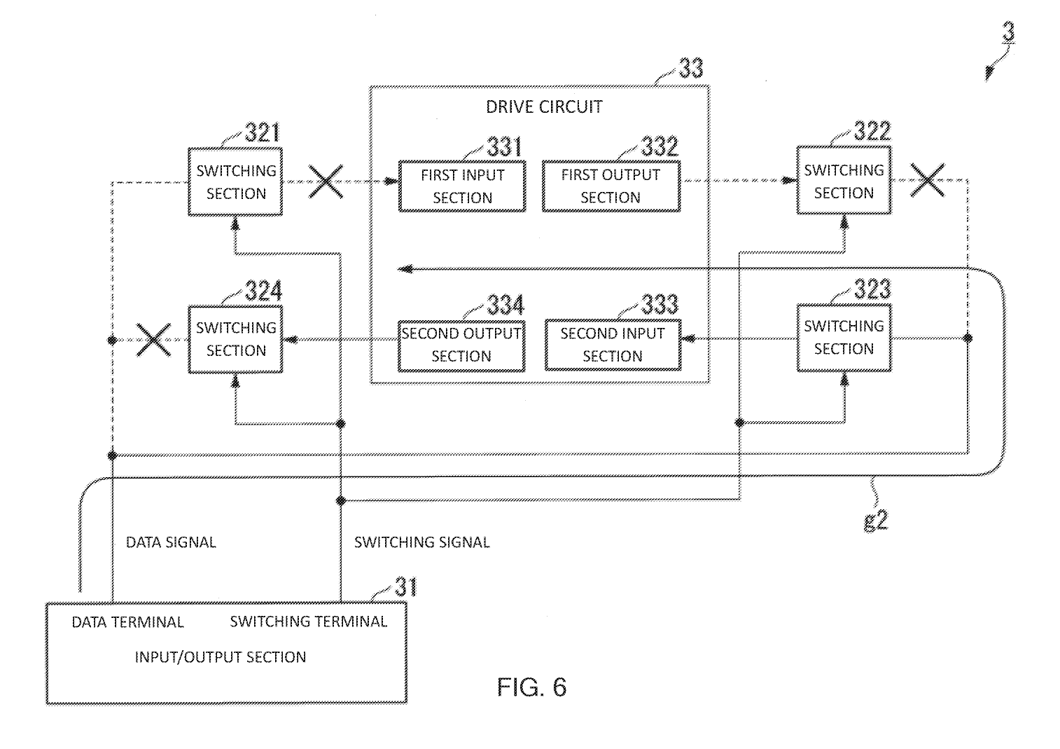

Then, a flow of the data signal of the head drive circuit 3 will be described using FIG. 5 and FIG. 6.

FIG. 5 is a block diagram showing the flow of the data signal in the case in which the data signal is input from the first input section 331 according to the present embodiment.

The switching signal in the state shown in FIG. 5 switches the switching section 321 so that a signal input to the switching section 321 is output, switches the switching section 322 so that a signal input to the switching section 322 is not output, switches the switching section 323 so that a signal input to the switching section 323 is not output, and switches the switching section 324 so that a signal input to the switching section 324 is not output.

In this state, each of the output end of the switching section 322, the output end of the switching section 323, and the output end of the switching section 324 becomes high-impedance, namely the state in which the signal input is not output.

As a result, as indicated by the arrow g1, the data signal output by the input/output section 31 is input to the first input section 331 of the drive circuit 33 via the switching section 321. The data signal input to the first input section 331 is output from the first output section 332 to the input end of the switching section 322. Further, the switching section 322 is in the state of not outputting the data signal.

Further, the switching section 323 is in the state of not outputting a signal, and the switching section 324 is in the state of not outputting a signal.

Thus, it is possible to prevent the signal output by the data terminal of the input/output section 31 from colliding with the output end of the switching section 322 and the output end of the switching section 324.

FIG. 6 is a block diagram showing the flow of the data signal in the case in which the data signal is input from the second input section 333 according to the present embodiment.

The switching signal in the state shown in FIG. 6 switches the switching section 321 so that a signal input to the switching section 321 is not output, switches the switching section 322 so that a signal input to the switching section 322 is not output, switches the switching section 323 so that a signal input to the switching section 323 is output, and switches the switching section 324 so that a signal input to the switching section 324 is not output.

In this state, each of the output end of the switching section 321, the output end of the switching section 322, and the output end of the switching section 324 becomes high-impedance, namely the state in which the signal input is not output.

As a result, as indicated by the arrow g2, the data signal output by the input/output section 31 is input to the second input section 333 of the drive circuit 33 via the switching section 323. The data signal input to the second input section 333 is output from the second output section 334 to the input end of the switching section 324. Further, the switching section 324 is in the state of not outputting a signal.

Further, the switching section 321 is in the state of not outputting a signal, and the switching section 322 is in the state of not outputting a signal.

Thus, it is possible to prevent the signal output by the data terminal of the input/output section 31 from colliding with the output end of the switching section 322 and the output end of the switching section 324.

It should be noted that although in the example shown in FIG. 4 through FIG. 6, there is described the example in which the switching sections 32 are externally attached to the drive circuit 33, this example is not a limitation. It is also possible to provide some or all of the switching sections 32 to the drive circuit 33.

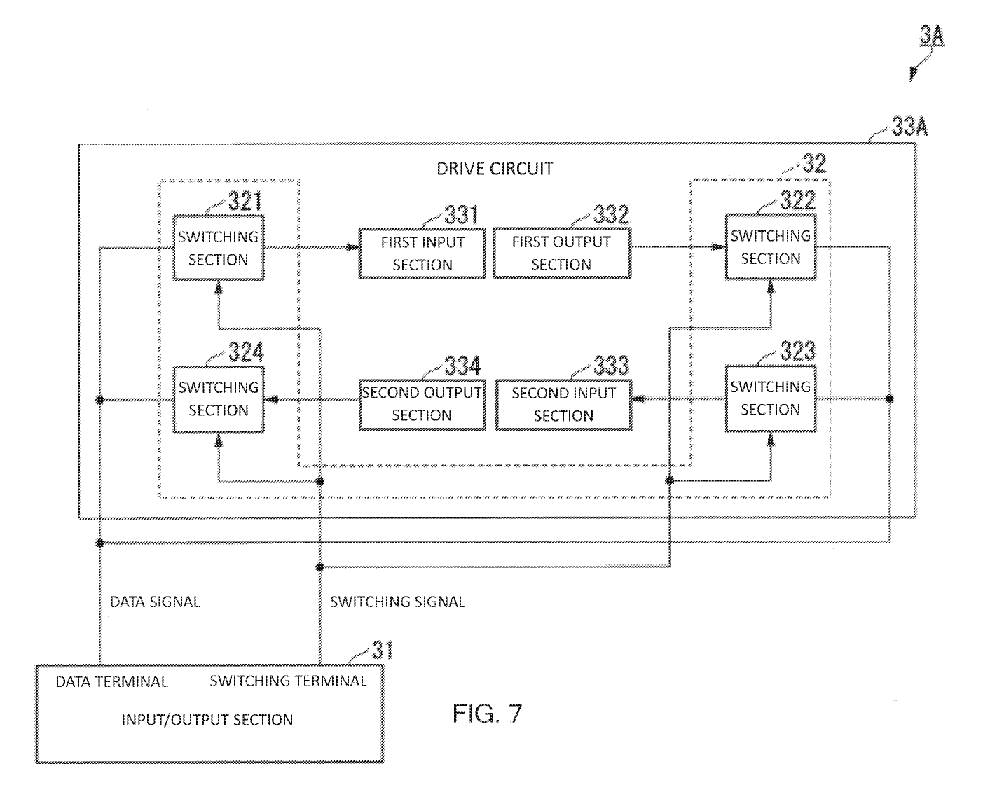

FIG. 7 is a block diagram showing a configuration example of the head drive circuit 3A according to the present embodiment in which the drive circuit 33A is provided with the switching sections 32. As shown in FIG. 7, the head drive circuit 3A is provided with the input/output section 31, and the drive circuit 33A. It should be noted that in FIG. 4, the latch circuit 34 and the waveform signal generation circuit are omitted from the illustration.

The drive circuit 33A is provided with the switching sections 32, the first input section 331, the first output section 332, the second input section 333, and the second output section 334.

It should be noted that the connection relationship between the sections is substantially the same as that of the head drive circuit 3 shown in FIG. 4. Further, the operation of the switching signal, and the flow of the data signal are substantially the same as shown in FIG. 5 and FIG. 6.

As described hereinabove, in the present embodiment, each of the input sections and the output sections of the drive circuit 33A is provided with the switching section 32, and it is arranged that the switching sections 32 are switched in accordance with the switching signal. Thus, the switching sections are switched so that the data signal is not input to the second input section 333, and the data signal is not output from the first output section 332 and the second output section 334 when the data signal is input from the first input section 331.

Thus, according to the present embodiment, by switching the settings of the input section which inputs the data to the drive circuit and the output sections which do not perform the output, it is possible to prevent the collision of the data, and therefore, it is possible to integrate the input sections and the output sections. As a result, according to the present embodiment, it is possible to reduce the number of the connection lines to the device for outputting data to the printing device. Thus, reduction in size and cost of the printing device can be achieved.

### Second Embodiment

Although in the first embodiment, there is described the example in which the printing device 1 is equipped with the single head drive circuit 3, it is also possible to adopt two or more head drive circuits.

In the present embodiment, there is described an example in which the printing device is equipped with N (N is an integer equal to or greater than 2) head drive circuits.

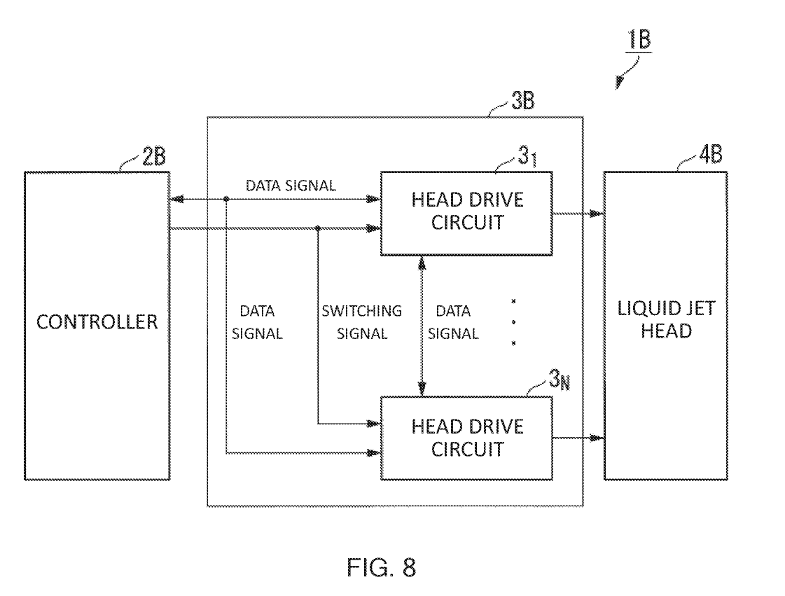

FIG. 8 is a block diagram showing a schematic configuration example of the printing device 1B according to the present embodiment. As shown in FIG. 8, the printing device 1B is configured including a controller 2B, a head drive circuit 3B (head drive circuits 3₁, 32, . . . , 3_{N-1}, 3_{N}), and a liquid jet head 4B.

In the configuration shown in FIG. 8, the plurality of head drive circuits 3₁, 3₂, . . . , 3_{N-1}, 3_{N} is connected to the single liquid jet head 4B. In such a configuration, for example, the liquid jet head 4B is provided with 256 nozzles, and with respect to these nozzles, the head drive circuits 3₁, 3₂ each drive the 128 nozzles.

In the example shown in FIG. 8, the controller 2B outputs the data signal to the head drive circuit 3₁ and the head drive circuit 3_{N}. Then, in accordance with the switching signal, the head drive circuit 3₁ outputs the data signal to the head drive circuit 3₂, . . . , and the head drive circuit 3_{N-1} outputs the data signal to the head drive circuit 3_{N}. Alternatively, in accordance with the switching signal, the head drive circuit 3_{N} outputs the data signal to the head drive circuit 3_{N-1}, . . . , and the head drive circuit 3₂ outputs the data signal to the head drive circuit 3₁.

Further, the controller 2B outputs the switching signal to the head drive circuits 3₁, 3₂, . . . , 3_{N-1}, 3_{N}.

The head drive circuits 3₁, 3₂, . . . , 3_{N-1}, 3_{N} drive the nozzles provided to the liquid jet head 4B to perform printing.

Then, a configuration example of the head drive circuit 3B will be described.

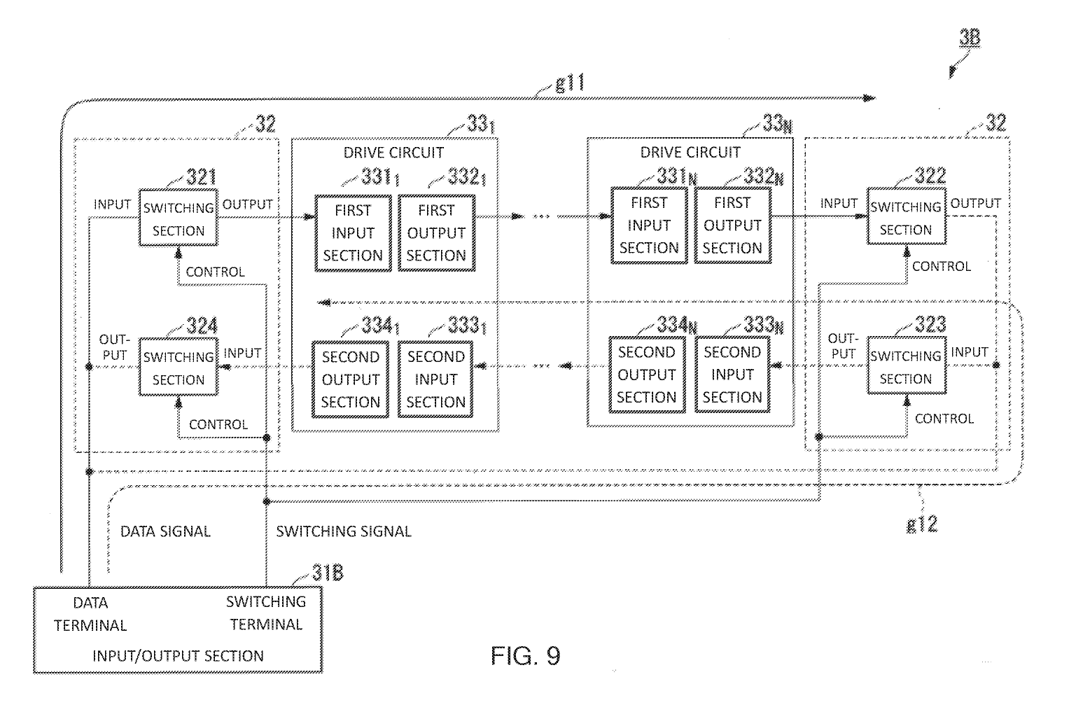

FIG. 9 is a block diagram showing the configuration example of the head drive circuit 3B according to the present embodiment. As shown in FIG. 9, the head drive circuit 3B is provided with an input/output section 31B, the switching sections 32, a drive circuit 33₁, . . . , and a drive circuit 33_{N}.

Further, the switching sections 32 consist of a switching section 321, a switching section 322, a switching section 323, and a switching section 324.

The drive circuit 33₁ is provided with a first input section 331₁, a first output section 332₁, a second input section 333₁, and a second output section 334₁.

The drive circuit 33_{N} is provided with a first input section 331_{N}, a first output section 332_{N}, a second input section 333_{N}, and a second output section 334_{N}.

It should be noted that in FIG. 9, the latch circuit 34 (see FIG. 3) and the waveform signal generation circuit 35 (see FIG. 3) are omitted from the illustration.

A data terminal of the input/output section 31B is connected to an input end of the switching section 321, an output end of the switching section 322, an input end of the switching section 323, and an output end of the switching section 324. A switching terminal of the input/output section 31B is connected to a control end of the switching section 321, a control end of the switching section 322, a control end of the switching section 323, and a control end of the switching section 324.

An output end of the switching section 321 is connected to the first input section 331₁ of the drive circuit 33₁.

The first output section 332₁ of the drive circuit 33₁ is connected to a first input section 331₂ of the drive circuit 33₂.

A first output section 332_{N-1} of the drive circuit 33_{N-1} is connected to the first input section 331_{N} of the drive circuit 33_{N}.

The first output section 332_{N} of the drive circuit 33_{N} is connected to an input end of the switching section 322.

An output end of the switching section 323 is connected to the second input section 333_{N} of the drive circuit 33_{N}.

The second output section 334_{N} of the drive circuit 33_{N} is connected to the second input section 333_{N-1} of the drive circuit 33_{N-1}.

The second output section 334₂ of the drive circuit 33₂ is connected to the second input section 333₁ of the drive circuit 33₁.

The second output section 334₁ of the drive circuit 33₁ is connected to an input end of the switching section 324.

Then, a flow of the data signal of the head drive circuit 3B will be described with reference to FIG. 9.

The switching signal in the state shown in FIG. 9 switches the switching section 321 so that a signal input to the switching section 321 is output, switches the switching section 322 so that a signal input to the switching section 322 is not output, switches the switching section 323 so that a signal input to the switching section 323 is not output, and switches the switching section 324 so that a signal input to the switching section 324 is not output.

In this state, each of the output end of the switching section 322, the output end of the switching section 323, and the output end of the switching section 324 becomes high-impedance, namely the state in which the signal input is not output.

As a result, as indicated by the arrow g11, the data signal output by the input/output section 31B is input to the first input section 331₁ of the drive circuit 33₁ via the switching section 321. The data signal input to the first input section 331₁ is output from the first output section 332₁ to the first input section 331₂ of the drive circuit 33₂. The data signal input to the first input section 331_{N-1} of the drive circuit 33_{N-1} is output from the first output section 332_{N-1} to the first input section 331_{N} of the drive circuit 33_{N}. Then, the data signal input to the first input section 331_{N} of the drive circuit 33_{N} is output from the first output section 332_{N} to the input end of the switching section 322. Further, the switching section 322 is in the state of not outputting a signal.

Further, the switching section 323 is in the state of not outputting a signal, and the switching section 324 is in the state of not outputting a signal.

Thus, the data signal output from the data terminal of the input/output section 31B is transmitted from the drive circuit 33₁ to the drive circuit 33₂, from the drive circuit 33₂ to the drive circuit 33₃, . . . , and from the drive circuit 33_{N-1} to the drive circuit 33_{N}. Further, similarly to the first embodiment, it is possible to prevent the signal output by the data terminal of the input/output section 31B from colliding with the output end of the switching section 322 and the output end of the switching section 324.

Then, there will be described a flow of a signal in the state in which the switching signal switches the switching section 321 so that a signal input to the switching section 321 is not output, switches the switching section 322 so that a signal input to the switching section 322 is not output, switches the switching section 323 so that a signal input to the switching section 323 is output, and switches the switching section 324 so that a signal input to the switching section 324 is not output.

In this state, each of the output end of the switching section 321, the output end of the switching section 322, and the output end of the switching section 324 becomes high-impedance, namely the state in which the signal input is not output.

As a result, as indicated by the arrow g12, the data signal output by the input/output section 31B is input to the second input section 333_{N} of the drive circuit 33_{N} via the switching section 323. The data signal input to the second input section 333_{N} is output from the second output section 334_{N} to the second input section 333_{N-1} of the drive circuit 33_{N-1}. The data signal input to the second input section 333₂ of the drive circuit 33₂ is output from the second output section 334₂ to the second input section 333₁ of the drive circuit 33₁. Then, the data signal input to the second input section 333₁ of the drive circuit 33₁ is output from the second output section 334₁ to the input end of the switching section 324. Further, the switching section 324 is in the state of not outputting a signal.

Further, the switching section 321 is in the state of not outputting a signal, and the switching section 322 is in the state of not outputting a signal.

Thus, the data signal output from the data terminal of the input/output section 31B is transmitted from the drive circuit 33_{N} to the drive circuit 33_{N-1}, . . . , and from the drive circuit 33₂ to the drive circuit 33₁. Further, similarly to the first embodiment, it is possible to prevent the signal output by the data terminal of the input/output section 31B from colliding with the output end of the switching section 322 and the output end of the switching section 324.

As described above, in the present embodiment, the switching sections 32 are connected to the drive circuits 33₁, 33_{N}.

Due to this configuration, according to the present embodiment, in the case of using the plurality of drive circuits 33 connected to one another, the switching sections 32 are connected outside the drive circuits 33₁, 33_{N}. Therefore, according to the present embodiment, in the case of, for example, using the plurality of drive circuits 33 connected to one another, it is possible to deal with the case by an externally attached circuit without changing the internal circuits of the drive circuits 33. As a result, according to the present embodiment, the degree of freedom of the configuration can be enhanced. Further, it is possible to reduce time and cost for design change of the drive circuits 33.

It should be noted that although in the example shown in FIG. 9, there is shown the example of connecting the switching sections to the drive circuit 33₁ and the drive circuit 33_{N} located on both sides, it is also possible for the drive circuits to be provided with the switching sections similarly to the first embodiment.

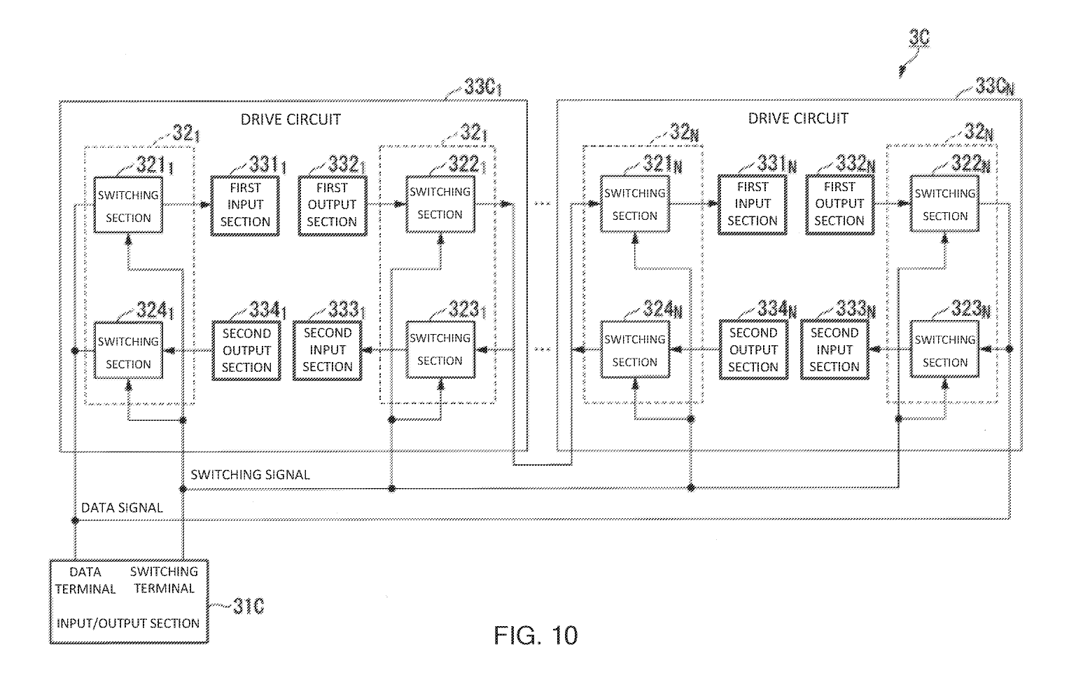

FIG. 10 is a block diagram showing a configuration example of the head drive circuit according to the present embodiment and having drive circuits provided with switching sections. As shown in FIG. 10, a head drive circuit 3C is provided with an input/output section 31C, a drive circuit 33C₁, . . . , and a drive circuit 33C_{N}. It should be noted that in FIG. 10, the latch circuit 34 (see FIG. 3) and the waveform signal generation circuit 35 (see FIG. 3) are omitted from the illustration.

The drive circuit 33C₁ is provided with a switching sections 32₁ (a switching section 321₁, a switching section 322₁, a switching section 323₁, and a switching section 324₁), the first input section 331₁, the first output section 332₁, the second input section 333₁, and the second output section 334₁.

The drive circuit 33C_{N} is provided with a switching sections 32_{N} (a switching section 321_{N}, a switching section 322_{N}, a switching section 323_{N}, and a switching section 324_{N}), the first input section 331_{N}, the first output section 332_{N}, the second input section 333_{N}, and the second output section 334_{N}.

A data terminal of the input/output section 31C is connected to an input end of the switching section 321₁ of the drive circuit 33C₁, an output end of the switching section 322_{N} of the drive circuit 33C_{N}, an input end of the switching section 323_{N} of the drive circuit 33C_{N}, and an output end of the switching section 324₁ of the drive circuit 33C₁.

A switching terminal of the input/output section 31C is connected to a control end of the switching section 32₁ of the drive circuit 33C₁, . . . , and a control end of the switching section 32_{N} of the drive circuit 33C_{N}.

An output end of the switching section 321₁ of the drive circuit 33C₁ is connected to the first input section 331₁ of the drive circuit 33C₁.

The first output section 332₁ of the drive circuit 33C₁ is connected to an input end of the switching section 322₁ of the drive circuit 33C₁.

An output end of the switching section 322₁ of the drive circuit 33C₁ is connected to an input end of the switching section 321₂ of the drive circuit 33C₂, an output end of the switching section 324₂ of the drive circuit 33C₂, and an input end of the switching section 323₁ of the drive circuit 33C₁.

An output end of the switching section 321_{N} of the drive circuit 33C_{N} is connected to the first input section 331_{N} of the drive circuit 33C_{N}.

The first output section 332_{N} of the drive circuit 33C_{N} is connected to an input end of the switching section 322_{N} of the drive circuit 33C_{N}.

An output end of the switching section 323_{N} of the drive circuit 33C_{N} is connected to the second input section 333_{N} of the drive circuit 33C_{N}.

The second output section 334_{N} of the drive circuit 33C_{N} is connected to an input end of the switching section 324_{N} of the drive circuit 33C_{N}.

An output end of the switching section 324_{N} of the drive circuit 33C_{N} is connected to an input end of the switching section 323_{N-1} of the drive circuit 33C_{N-1}, an output end of the switching section 322_{N-1} of the drive circuit 33C_{N-1}, and an input end of the switching section 321_{N} of the drive circuit 33C_{N}.

An output end of the switching section 323₁ of the drive circuit 33C₁ is connected to the second input section 333₁ of the drive circuit 33C₁.

The second output section 334₁ of the drive circuit 33C₁ is connected to an input end of the switching section 324₁ of the drive circuit 33C₁.

Then, there will be described a flow of the data signal in the state in which the switching signal switches the switching section 321₁ of the drive circuit 33C₁ so that the signal input to the switching section 321₁ is output, . . . , switches the switching section 321_{N-1} of the drive circuit 33C_{N-1} so that the signal input to the switching section 321_{N-1} is output, switches the switching section 322_{N} of the drive circuit 33C_{N} so that the signal input to the switching section 322_{N} is not output, switches the switching section 323_{N} of the drive circuit 33C_{N} so that the signal input to the switching section 323_{N} is not output, . . . , and switches the switching section 324₁ of the drive circuit 33C₁ so that the signal input to the switching section 324₁ is not output.

In this state, each of the output end of the switching section 322_{N} of the drive circuit 33C_{N}, and the output end of the switching section 323_{N} of the drive circuit 33C_{N} becomes high-impedance, namely the state in which the signal input is not output. In this state, each of the output end of the switching section 324_{N} of the drive circuit 33C_{N}, . . . , and the output end of the switching section 324₁ of the drive circuit 33C₁ becomes high-impedance, namely the state in which the signal input is not output.

As a result, the data signal output by the input/output section 31C is input to the first input section 331₁ of the drive circuit 33C₁ via the switching section 321₁ of the drive circuit 33C₁. The data signal input to the first input section 331₁ of the drive circuit 33C₁ is output from the first output section 332₁ of the drive circuit 33C₁ to the switching section 321₂ of the drive circuit 33C₂ via the switching section 322₁ of the drive circuit 33C₁. The data signal input to the switching section 321₂ of the drive circuit 33C₂ is output to the first input section 331₂ of the drive circuit 33C₂. The data signal input to the switching section 321_{N-1} of the drive circuit 33C_{N-1} is output to the first input section 331_{N-1} of the drive circuit 33C_{N-1}. The data signal input to the first input section 331_{N-1} of the drive circuit 33C_{N-1} is output from the first output section 332_{N-1} of the drive circuit 33C_{N-1} to the switching section 321_{N} of the drive circuit 33C_{N} via the switching section 322_{N-1} of the drive circuit 33C_{N-1}. The data signal input to the switching section 321_{N} of the drive circuit 33C_{N} is output to the first input section 331_{N} of the drive circuit 33C_{N}. The data signal input to the first input section 331_{N} of the drive circuit 33C_{N} is output from the first output section 332_{N} of the drive circuit 33C_{N} to the switching section 322_{N} of the drive circuit 33C_{N}. Further, the switching section 322_{N} of the drive circuit 33C_{N} is in the state of not outputting a signal.

Further, the switching section 323_{N} of the drive circuit 33C_{N} is in the state of not outputting a signal, the switching section 323_{N-1} of the drive circuit 33C_{N-1} is in the state of not outputting a signal, . . . , and the switching section 324₁ of the drive circuit 33C₁ is in the state of not outputting a signal.

Thus, the data signal output from the data terminal of the input/output section 31C is transmitted from the drive circuit 33C₁ to the drive circuit 33C₂ via the switching section 322₁ of the drive circuit 33C₁ and the switching section 321₂ of the drive circuit 33C₂. Subsequently, the data signal is transmitted from the drive circuit 33C₂ to the drive circuit 33C₃, . . . , from the drive circuit 33C_{N-1} to the drive circuit 33C_{N} via the switching section 322_{M} and the switching section 321_{M+1} respectively provided to the drive circuits 33C_{M} (M is an integer from 2 to N-1). Further, similarly to the first embodiment, it is possible to prevent the signal output by the data terminal of the input/output section 31C from colliding with the output end of the switching section 322_{N} of the drive circuit 33C_{N} and the output end of the switching section 324₁ of the drive circuit 33C₁.

As described above, in the present embodiment, the drive circuits 33C each have the switching sections 32.

Due to this configuration, according to the present embodiment, since the drive circuit 33C is provided with the switching sections 32, it is possible to reduce the number of constituents in the case of using the plurality of drive circuits 33C connected to one another, and thus, reduction in size and cost of the printing device can be achieved.

Further, according to the present embodiment, even in the case of using the plurality of drive circuits 33C connected to one another, by switching the settings of the input section which inputs the data to the drive circuit 33C and the output sections which do not perform the output using the switching sections 32, it is possible to prevent the collision of the data, and therefore, it is possible to adopt the input/output section 31 integrating the input sections and the output sections of the data signal. Thus, according to the present embodiment, it is possible to reduce the number of the connection lines to the device for outputting data to the printing device. Further, according to the present embodiment, reduction in size and cost of the printing device can be achieved.

### Modified Example of Second Embodiment

Here, a modified example of the second embodiment will be described.

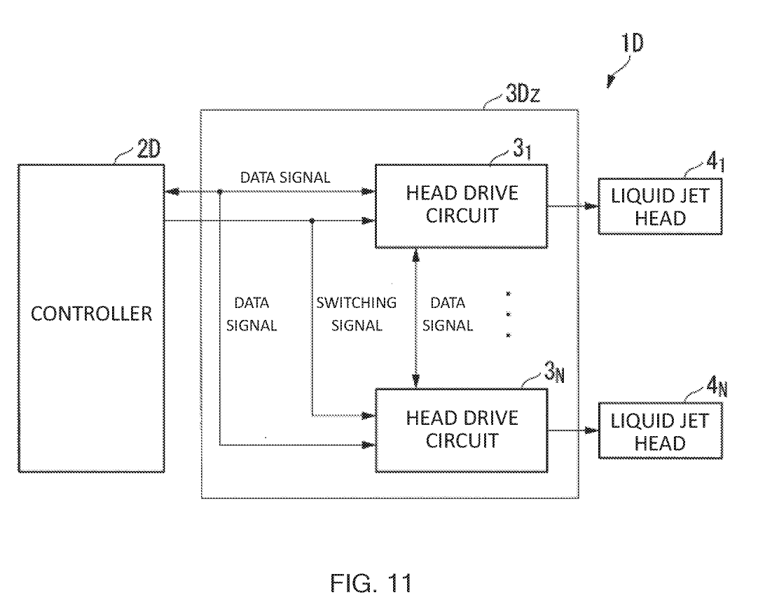

FIG. 11 is a block diagram showing a schematic configuration example of a printing device 1D according to the modified example of the present embodiment. As shown in FIG. 11, the printing device 1D is configured including a controller 2D, head drive circuits 3D (head drive circuits 3₁, 3₂, . . . , 3_{N-1}, 3_{N}), and liquid jet heads 4₁, 4₂, . . . , 4_{N-1}, 4_{N}.

It should be noted that in the example shown in FIG. 11, there is shown an example in which the head drive circuits 3 are each provided with one liquid jet head 4, but this example is not a limitation. The number of the liquid jet heads 4 can be two or more, for example, eight.

In the example shown in FIG. 11, the controller 2D outputs the data signal to the head drive circuits 3₁, 3_{N}. In accordance with the switching signal, the head drive circuit 3₁ outputs the data signal to the head drive circuit 3₂, . . . , and the head drive circuit 3_{N-1} outputs the data signal to the head drive circuit 3_{N}. Alternatively, in accordance with the switching signal, the head drive circuit 3_{N} outputs the data signal to the head drive circuit 3_{N-1}, . . . , and the head drive circuit 3₂ outputs the data signal to the head drive circuit 3₁.

Further, the controller 2D outputs the switching signal to the head drive circuits 3₁, 3₂, . . . , 3_{N-1}, 3_{N}.

The head drive circuit 3₁ drives the nozzles provided to the liquid jet head 4₁ to perform printing, . . . , and the head drive circuit 3_{N} drives the nozzles provided to the liquid jet head 4_{N} to perform printing.

It should be noted that in the configuration shown in FIG. 11, the configuration of the drive circuits 33 provided to each of the head drive circuits 3₁, 3₂, . . . , 3_{N-1}, 3_{N} is substantially the same as shown in FIG. 9, or FIG. 10.

### DESCRIPTION OF COMPARATIVE EXAMPLE

Here, a configuration example of a comparative example, and an example of a flow of a data signal will be described.

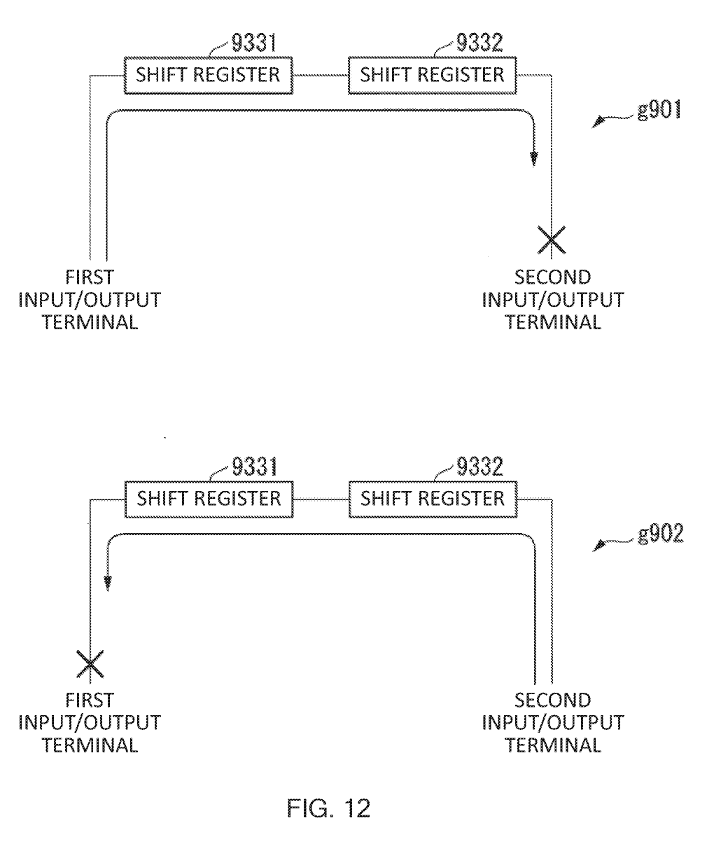

FIG. 12 is a block diagram showing a configuration example and an example of the flow of the signal in the comparative example in which two shift registers are connected to each other.

As the comparative example, the shift registers alone are extracted from the head drive circuit as shown in FIG. 12. In the case in which the two shift registers are connected to each other, a first input/output terminal for inputting data from the shift register 9331 side as an area indicated by the symbol g901, and a second input/output terminal for inputting data from the shift register 9332 side as an area indicated by the symbol g902 are necessary for the input/output section.

In the configuration shown in the comparative example, in the case of using 4-bit data, four signal lines for each of the first input/output terminal and the second input/output terminal, namely eight signal lines in total are necessary. Further, in the case of using 8-bit data, eight signal lines for each, namely sixteen signal lines are necessary.

The large number of signal lines for these terminals is an obstructive factor for reduction in size of the head drive circuit.

Such a head drive circuit is integrated with the head as a unit, and is mounted on a single board in some cases. In the case of, for example, bonding the head drive circuits back to back to each other, since the heads are installed in the two units, it is necessary to uniform the flow direction of data. Therefore, as in the area indicated by the symbol g901 and the area indicated by the symbol g902 in FIG. 12, it is necessary to make the data flow counterclockwise and clockwise, respectively. Further, in order to make it possible to make the data flow in either of the directions, it is necessary to provide both of the input/output terminals for clockwise flow and counterclockwise flow in the data bus (the input/output section) in the comparative example shown in FIG. 12.

In contrast, in the present embodiment, as described above, by switching the settings of the input section which inputs the data to the drive circuit 33 and the output sections which do not perform the output using the switching sections 32, it is possible to prevent the collision of the data in the input/output section 31. Thus, according to the present embodiment, in the input/output section 31, it is possible to integrate the input section and the output section with each other. As a result, according to the present embodiment, it is possible to reduce the number of the connection lines to the device for outputting data to the printing device, and thus, it is possible to achieve the reduction in size and cost of the printing device.

It should be noted that the printing devices 1 (1B, 1D) described in the first embodiment and the second embodiment can also be of other types such as a thermal (Bubble Jet (registered trademark)) type.

It should be noted that it is also possible to store a program for realizing a part or the whole of the function of the head drive circuit 3 (or 3A, 3B, 3C, 3₁, . . . , 3_{N}) according to the invention in a computer-readable recording medium, and then make a computer system retrieve and execute the program stored in the recording medium to thereby perform a part or the whole of the process performed by the head drive circuit 3 (or 3A, 3B, 3C, 3₁, . . . , 3_{N}). It should be noted that the “computer system” mentioned here should include an OS and the hardware such as peripheral devices. Further, the “computer system” should also include a WWW system provided with a home page providing environment (or a display environment). Further, the “computer-readable recording medium” denotes a portable recording medium such as a flexible disk, a magneto-optical disk, a ROM, a CD-ROM, or a flash memory, or a storage device such as a hard disk incorporated in the computer system. Further, the “computer-readable recording medium” should include those holding a program for a certain period of time such as a volatile memory (a RAM) in a computer system to be a server or a client in the case of transmitting the program via a network such as the Internet, or a communication line such as a telephone line.

Further, the program described above can be transmitted from the computer system having the program stored in the storage device or the like to another computer system via a transmission medium or with a transmission wave in the transmission medium. Here, the “transmission medium” for transmitting the program denotes a medium having a function of transmitting information such as a network (a communication network) such as the Internet or a communication line (a communication wire) such as a telephone line. Further, the program described above can be for realizing a part of the function described above. Further, the program described above can be a program, which can realize the function described above in combination with a program having already been recorded on the computer system, namely a so-called differential file (a differential program).

The configurations for implementing the invention are hereinabove described using the embodiments, but the invention is not at all limited to such embodiments, and is subject to a variety of modifications and replacements within the scope and spirit of the invention.

What is claimed is:

1. A printing device adapted to perform bidirectional data transmission/reception, comprising:
an input/output section adapted to perform input and output of data;
a drive circuit adapted to output the data, which is input from the input/output section, to the input/output section so as to perform printing based on the data; and
a switching section adapted to switch an input direction and an output direction of the data to the drive circuit in accordance with a switching signal,
wherein the drive circuit is provided with a first input section to which the data is input, a first output section adapted to output the data, which is input from the first input section, to the input/output section, a second input section to which the data is input, and a second output section adapted to output the data, which is input from the second input section, to the input/output section, and
the switching section switches, in accordance with the switching signal, between a state in which the data input from the input/output section is input to the first input section while the data input to the first input section fails to be output to the input/output section, and a state in which the data input from the input/output section is input to the second input section while the data input to the second input section fails to be output to the input/output section.

2. The printing device according to claim 1, wherein
the switching sections are connected respectively to the first input section, the first output section, the second input section, and the second output section of the drive circuit.

3. The printing device according to claim 1, wherein
the switching sections are provided to the drive circuit, and are connected respectively to the first input section, the first output section, the second input section, and the second output section.

4. The printing device according to claim 1, wherein
the drive circuit is provided with N (N is an integer no smaller than 2) drive circuits of first, second, . . . , N-1-th, and N-th drive circuits,
the first output section of the first drive circuit is connected to the first input section of the second drive circuit,
the first output section of the N-1-th drive circuit is connected to the first input section of the N-th drive circuit,
the second output section of the N-th drive circuit is connected to the second input section of the N-1-th drive circuit,
the second output section of the second drive circuit is connected to the second input section of the first drive circuit, and
the switching section switches, in accordance with the switching signal, between
a state in which the data input from the input/output section is input to the first input section of the first drive circuit, the data input to the first input section of the first drive circuit is output from the first output section of the first drive circuit to the first input section of the second drive circuit, and the data input to the first input section of the N-1-th drive circuit is output from the first output section of the N-1-th drive circuit to the first input section of the N-th drive circuit, and fails to be output from the first output section of the N-th drive circuit to the input/output section, and
a state in which the data input from the input/output section is input to the second input section of the N-th drive circuit, the data input to the second input section of the N-th drive circuit is output from the second output section of the N-th drive circuit to the second input section of the N-1-th drive circuit, and the data input to the second input section of the second drive circuit is output from the second output section of the second drive circuit to the second input section of the first drive circuit, and fails to be output from the second output section of the first drive circuit to the input/output section.

5. The printing device according to claim 1, wherein
the drive circuit is provided with N (N is an integer no smaller than 2) drive circuits of first, second, . . . , N-1-th, and N-th drive circuits,
each of the N drive circuits is provided with the switching sections,
the switching sections are connected respectively to the first input section, the first output section, the second input section, and the second output section of the first drive circuit,
the switching sections are connected respectively to the first input section, the first output section, the second input section, and the second output section of the second drive circuit,
the switching sections are connected respectively to the first input section, the first output section, the second input section, and the second output section of the N-1-th drive circuit,
the switching sections are connected respectively to the first input section, the first output section, the second input section, and the second output section of the N-th drive circuit,
the first output section of the first drive circuit is connected to the first input section of the second drive circuit via the switching section of the first drive circuit and the switching section of the second drive circuit,
the first output section of the N-1-th drive circuit is connected to the first input section of the N-th drive circuit via the switching section of the N-1-th drive circuit and the switching section of the N-th drive circuit,
the second output section of the N-th drive circuit is connected to the second input section of the N-1-th drive circuit via the switching section of the N-th drive circuit and the switching section of the N-1-th drive circuit,
the second output section of the second drive circuit is connected to the second input section of the first drive circuit via the switching section of the second drive circuit and the switching section of the first drive circuit, and
the switching sections switch, in accordance with the switching signal, between
a state in which the data input from the input/output section is input to the first input section of the first drive circuit, the data input to the first input section of the first drive circuit is output from the first output section of the first drive circuit to the first input section of the second drive circuit via the switching section of the first drive circuit and the switching section of the second drive circuit, and
the data input to the first input section of the N-1-th drive circuit is output from the first output section of the N-1-th drive circuit to the first input section of the N-th drive circuit via the switching section of the N-1-th drive circuit and the switching section of the N-th drive circuit, and fails to be output from the first output section of the N-th drive circuit to the input/output section, and
a state in which the data input from the input/output section is input to the second input section of the N-th drive circuit, the data input to the second input section of the N-th drive circuit is output from the second output section of the N-th drive circuit to the second input section of the N-1-th drive circuit via the switching section of the N-th drive circuit and the switching section of the N-1-th drive circuit, and
the data input to the second input section of the second drive circuit is output from the second output section of the second drive circuit to the second input section of the first drive circuit via the switching section of the second drive circuit and the switching section of the first drive circuit, and fails to be output from the second output section of the first drive circuit to the input/output section.

6. A method of controlling a printing device adapted to perform bidirectional data transmission/reception, the printing device including an input/output section adapted to perform input and output of data, a drive circuit adapted to output the data, which is input from the input/output section, to the input/output section so as to perform printing based on the data, and a switching section adapted to switch an input direction and an output direction of the data to the drive circuit in accordance with a switching signal, wherein the drive circuit is provided with a first input section to which the data is input, a first output section adapted to output the data, which is input from the first input section, to the input/output section, a second input section to which the data is input, and a second output section adapted to output the data, which is input from the second input section, to the input/output section, the method comprising:
switching, by the switching section in accordance with the switching signal, between a state in which the data input from the input/output section is input to the first input section while the data input to the first input section fails to be output to the input/output section, and a state in which the data input from the input/output section is input to the second input section while the data input to the second input section fails to be output to the input/output section.
